(19) United States
(12) Patent Application Publication
(10) Pub. No.: US 2020/0270946 A1
(43) Pub. Date: Aug. 27, 2020

(54) Lockable Ladder Tool Tray with Separable Paint Bucket

(71) Applicants: Mark W. Lawery, Salix, PA (US); Robert A. Low, Duncansville, PA (US)

(72) Inventors: Mark W. Lawery, Salix, PA (US); Robert A. Low, Duncansville, PA (US)

(21) Appl. No.: 16/283,886

(22) Filed: Feb. 25, 2019

(51) Int. Cl. E06C 7/14; B25H 3/06; B44D 3/12

(52) U.S. Cl. CPC E06C 7/14; B44D 3/126; B25H 3/06

(57) ABSTRACT

A ladder tool tray with separable paint bucket. The tool tray comprises a first section as a tool organizer and a second section for paint bucket. The second section is removably attached to the first section. The first section comprises a plurality of storage compartments and a lockdown element for securing the first section to the top of a ladder. The second section is a paint bucket with integrated hook to hold paint roller above the paint within the paint bucket.

### BACKGROUND

On some jobs, such as ceiling or a high wall painting, a person will need to frequently climb up and down to change hardware tools and dip paint rollers. Tool trays are well known for most handymen. However, there are not many choices of a ladder tool tray capable of holding paint such that a user can do paint job on ladder directly without multiple climbing efforts. Therefore, there is a need for a ladder and tray with separable paint bucket.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY OF THE INVENTION

The present invention features a ladder tool tray with separable paint bucket. The tool tray comprises a first section as a tool organizer and a second section for paint bucket. The second section is removably attached to the first section via securing clasps and a top bracket. The first section comprises a plurality of storage compartments. The second section is a paint bucket with integrated hook to hold paint roller above the paint within the paint bucket.

The first section includes a lockdown element for securing the first section to the top of the ladder.

### BRIEF DESCRIPTION OF THE DRAWINGS

FIG. 1 shows a perspective view of the ladder tool tray.

FIG. 2 shows a side view of the ladder tool tray.

FIG. 3 shows a perspective view of the first section of the ladder tool tray.

FIG. 4 shows a top view of the first section of the ladder tool tray.

FIG. 5 shows a bottom view of the first section of the ladder tool tray.

FIG. 6 shows a perspective view of the second section of the ladder tool tray.

FIG. 7 shows an exploded view of the ladder tool tray including the lockdown element.

### DETAILED DESCRIPTION OF THE PREFERRED EMBODIMENT

The disclosure of U.S. Pat. No. 8,636,144 ('144) is incorporated herein by reference in its entirety.

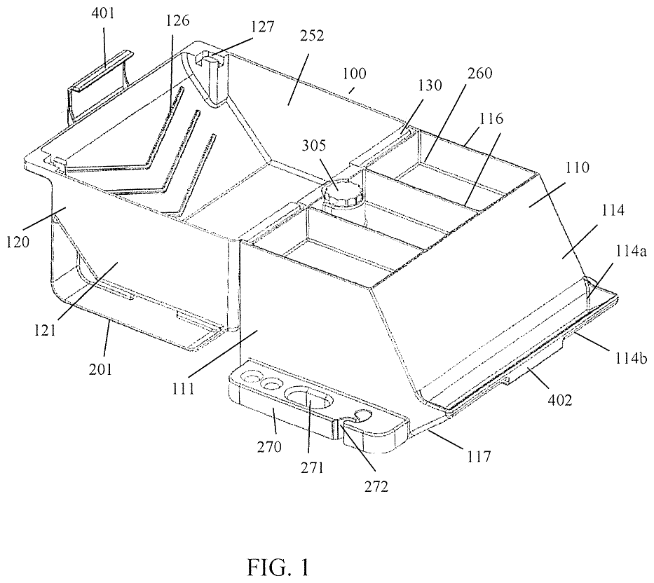

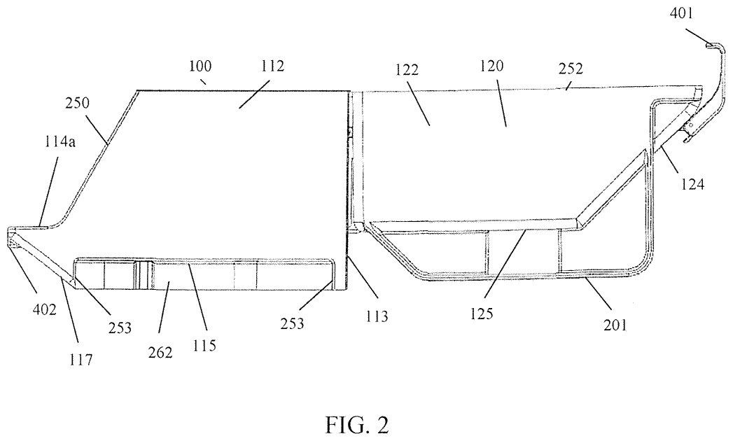

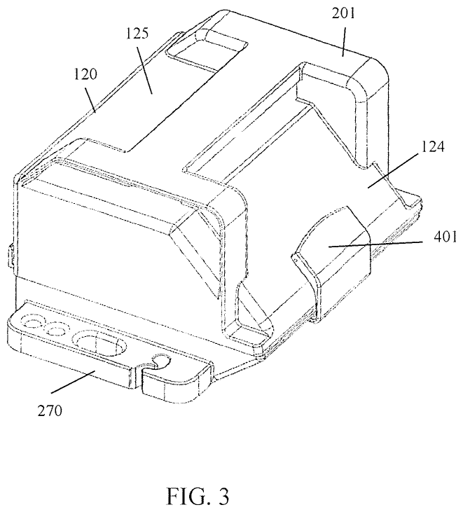

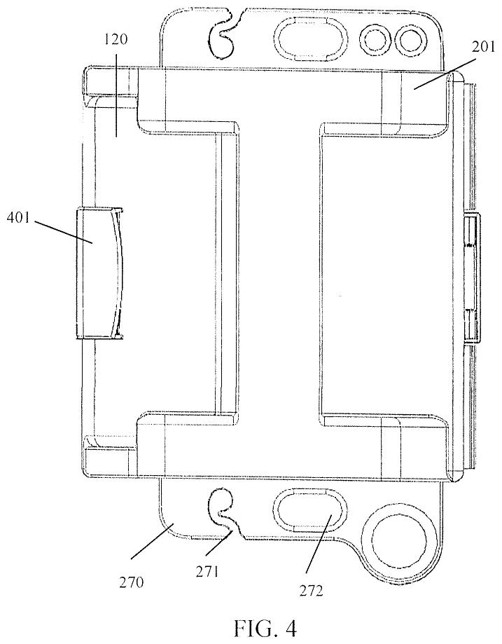

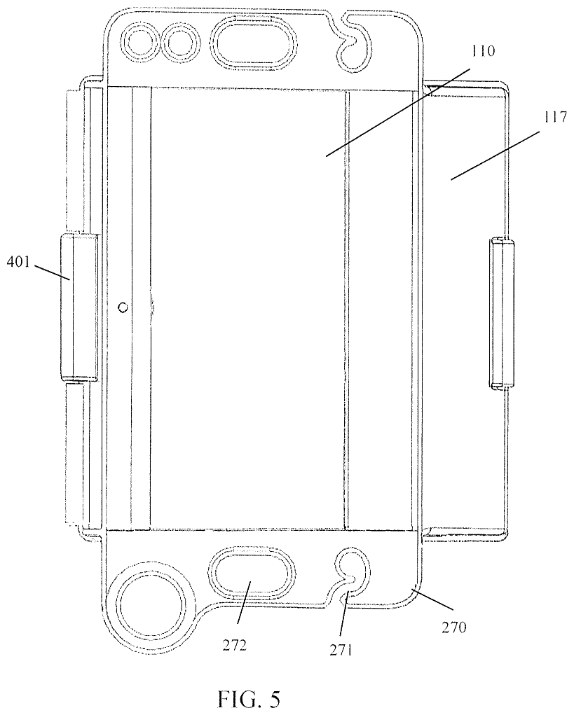

Referring now to FIGS. 1-7, the present invention features a ladder tool tray (100) comprising a first section (110) and a second section (120) with the first section (110) and second section (120) removably joined together by a connection means.

The first section (110) has a first side wall (111), a second side wall (112), a third wall (113), a fourth side wall (114) and a base panel (115), wherein the first side wall (111) is preferably parallel to the second side wall (112). The third side wall (113) is preferably perpendicular to the first side wall, and the fourth side wall (114) is preferably sloped as shown. As such an inner pocket (250) is formed by the first, second, third and fourth side walls and the base panel (115), and wherein a plurality of dividing walls (116) divide the inner pocket (250) into a plurality of inner compartments (260).

The first section further comprises a pair of lower walls (253) wherein a lower compartment (262) is formed, wherein the lower compartment (262) is configured to snugly receive a top step of a step ladder.

The second section (120) is functioned as a paint bucket, wherein the second section has a first bucket wall (121), a second bucket wall (122), a third bucket wall (123), a fourth bucket wall (124) and a base bucket wall (125), wherein a paint bucket compartment (252) is formed by the first, second, third and fourth bucket walls and the base bucket wall (125), wherein the fourth bucket (124) slopes to the base bucket wall (125) with a slope angle. A a plurality of ridges (126) are disposed on the fourth bucket wall (124), wherein the ridges (126) are functioned to roll off excessive paint from a sleeve of a paint roller (not shown, but shown in '144) after the sleeve is dipped with paint, wherein the second section (120) further comprises a paint roller hook (127) disposed on the first bucket wall (121) within the paint bucket compartment (252), wherein the paint roller hook (127) functions to hold a connection arm of the paint roller securely in position and thus prevent the paint roller from accidentally submerging within the paint bucket. The paint roller is well known to one of ordinary art in the field.

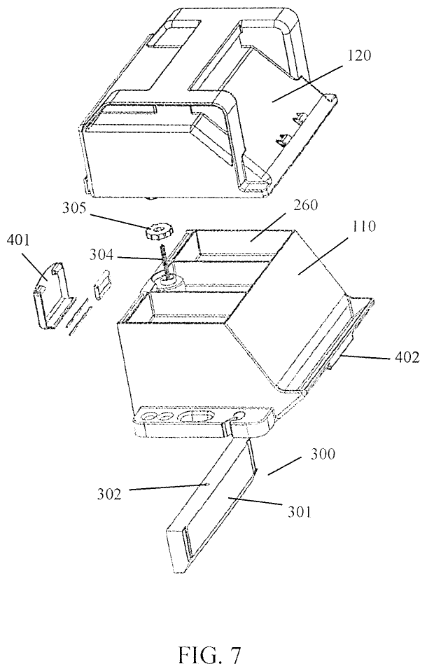

On bucket exterior (200) (see FIG. 7 for instance), lifting handle (201) is formed as a pair of upstanding members (202) which are non-coplanar with base bucket wall (125) of second section (120), thereby forming a gap such that the upstanding members (202) may be grasped and the second section (120) leveraged away from the first section (110).

Connection means here includes top connection bracket (130) integrally formed along bracket edge (131) of second section (120). Top connection bracket (130) is L-shaped with an overhang to define a groove (132) into which first section fits such that first section (110) mates with second section (120).

In some embodiments, a lockdown element (300) is included to allow the ladder tool tray (100) to be used on a variety of ladder types and sizes. Lockdown element (300) comprises a stabilizer (301), preferably wedged shaped. Stabilizer (301) is configured to abut the underside of a top step of a ladder for instance upon placement of first section (110). A stabilizer hole (302) is defined at stabilizer top edge (303) adapted to receive threaded stem (304). A screw adjuster knob (305) is threaded onto opposite end of threaded stem (304). As such, lockdown element (300) including stabilizer (301) can travel through the vertical plane to compress stabilizer onto ladder and be raised or lowered thus causing the securement, or lockdown of first section (110).

It should be understood that, like in '144, a variety of towel holders, tool supports and other tool receiving pockets can be implemented along each section. Here, for example, shown is the first support plate (270) comprising circular apertures (271) and a slot (272) for securing hammers or drills or the like.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1. (canceled)

2. (canceled)

3. (canceled)

4. A ladder tool tray, comprising,
a first section having a first side wall, a second side wall, a third wall, an outer slope, a fourth side wall, a lower compartment and a base panel;
said outer slope sloping upwards from said lower compartment perpendicular to said fourth side wall and terminating to form a receptacle, said receptacle having an outer edge;
a lip at said outer edge;
a pair of lower walls on said first section, said lower walls defining said lower compartment,
a second section having a bracket edge, a first bucket wall, a second bucket wall, a third bucket wall, a fourth bucket wall and a base bucket wall;
a clasp member attached to said fourth bucket wall adapted to engage said lip of said receptacle to thereby allow for the securement of said first section over second section;
a lockdown element, said lockdown element further comprising a top connection bracket integrally formed along said bracket edge, said top connection bracket L-shaped with an overhang to thereby define a groove into which said first section can fit such that said first section can mate with said second section, wherein upon disengagement of said clasp member from said lip, said first section is separable and disposed alongside said second section;
said lockdown element further comprising:
a wedge-shaped stabilizer;
a stabilizer hole defined within said stabilizer;
a threaded stem placed through said first section; and,
a screw adjuster knob for engaging said threaded stem.

5. (canceled)

6. (canceled)

7. (canceled)

8. (canceled)
